(19) United States
(12) Patent Application Publication
(10) Pub. No.: US 2021/0115962 A1
(43) Pub. Date: Apr. 22, 2021

(54) FASTENER STRUCTURE AND METHOD OF MANUFACTURING THE SAME

(71) Applicant: DTECH PRECISION INDUSTRIES CO., LTD., New Taipei City (TW)

(72) Inventor: TING-JUI WANG, New Taipei City (TW)

(21) Appl. No.: 17/013,841

(22) Filed: Sep. 7, 2020

(30) Foreign Application Priority Data
Oct. 22, 2019 (TW) 108138098

(51) Int. Cl. F16B 39/24; F16B 43/00

(52) U.S. Cl. CPC F16B 39/24; F16B 43/004

(57) ABSTRACT

A fastener structure and a method of manufacturing the same are introduced. The fastener structure includes a body portion and an engaging portion. The body portion is formed from a plate element shaped by being folded, shaped by being rolled or shaped by being pulled. The body portion has a receiving space. The engaging portion is movably fitted to the body portion. The engaging portion has a head portion and an engaging-connecting portion. The engaging-connecting portion is disposed in the receiving space. The body portion is movably fitted to the engaging portion and fitted to an object, whereas the engaging portion is engaged with another object or removed from another object, to not only fit together and separate at least two objects repeatedly and quickly but also render the fastener structure easy to manufacture.

### CROSS-REFERENCE TO RELATED APPLICATION

This non-provisional application claims priority under 35 U.S.C. § 119(a) on Patent Application No(s). 108138098 filed in Taiwan, R.O.C. on Oct. 22, 2019, the entire contents of which are hereby incorporated by reference.

### BACKGROUND OF THE INVENTION

### 1. Field of the Invention

The present disclosure relates to fastener structures and methods of manufacturing the same, and in particular to a fastener structure and a method of manufacturing the same to not only couple together and separate two or more objects repeatedly and quickly but also render the fastener structure easy to manufacture.

### 2. Description of the Related Art

Conventionally, coupling together two or more objects requires fastening the two or more objects together with screws in an inseparable manner. However, the two or more objects cannot be firmly coupled together.

### BRIEF SUMMARY OF THE INVENTION

An objective of the present disclosure is to provide a fastener structure and a method of manufacturing the same to movably fit a body portion to an engaging portion, fit the body portion to an object, and allow the engaging portion to be engaged with another object or removed from another object, so as to not only fit together and separate at least two objects repeatedly and quickly but also render the fastener structure easy to manufacture.

To achieve at least the above objective, the present disclosure provides a fastener structure comprising a body portion and an engaging portion. The body portion is formed from a plate element shaped by being folded or shaped by being rolled. The body portion has a receiving space. The engaging portion is movably fitted to the body portion. The engaging portion has a head portion and an engaging-connecting portion. The engaging-connecting portion is disposed in the receiving space.

The present disclosure further provides a fastener structure comprising a body portion and an engaging portion. The body portion is formed from a plate element shaped by being pulled. The body portion has a receiving space. The engaging portion is movably fitted to the body portion. The engaging portion has a head portion and an engaging-connecting portion. The engaging-connecting portion is disposed in the receiving space.

The present disclosure further provides a method of manufacturing a fastener structure. The fastener structure comprises a body portion and an engaging portion. The body portion is formed from a plate element shaped by being folded, shaped by being rolled or shaped by being pulled. The body portion forms a receiving space. The engaging portion has a head portion and an engaging-connecting portion. The engaging portion is movably fitted to the body portion. The engaging-connecting portion is disposed inside or outside the receiving space.

The present disclosure further provides a method of manufacturing a fastener structure. The fastener structure comprises a body portion and an engaging portion. The body portion is formed by stamping or pressing a plate element under an applied force so as for the plate element to be shaped by being folded, shaped by being rolled or shaped by being pulled, allowing a receiving space to be formed by the body portion. The engaging portion has a head portion and an engaging-connecting portion, and the engaging portion is movably fitted to the body portion, allowing the engaging-connecting portion to be disposed inside or outside the receiving space.

Therefore, the body portion and the engaging portion are movably fitted together. The body portion is fitted to an object, whereas the engaging portion is engaged with another object or removed from another object, so as to not only fit together and separate at least two objects repeatedly and quickly but also render the fastener structure easy to manufacture.

Preferably, the plate element or the body portion shaped has a first fitting portion, and the first fitting portion is fitted to an object.

Preferably, the first fitting portion has a raised portion, and the raised portion is compressed or is engaged with the object to fit thereto.

Preferably, the first fitting portion has a hole portion, slot portion, or dented portion which is compressed by or engaged with a raised portion of the object to thereby fit to the object.

Preferably, the first fitting portion is a hole portion, slot portion, raised portion, dented portion, plane portion, welding portion, engaging portion, fastening portion, riveting portion, expanding portion or engaging-connecting portion

Preferably, the plate element or the body portion shaped has one or two second fitting portions fitted to the engaging portion.

Preferably, the body portion is formed from the plate element stamped or pressed so as to be shaped by being folded or shaped by being rolled.

Preferably, the body portion is formed from the plate element stamped or pressed so as to be shaped by being pulled or shaped by being rolled.

Preferably, the receiving space is a folded structure or a rolled structure shaped by being folded or shaped by being rolled.

Preferably, the receiving space is a closed structure formed by pulling the material of the plate element.

Preferably, the engaging-connecting portion is a thread member, cylindrical member, external fastener or internal fastener.

Preferably, the body portion has a second fitting portion which is raised, dented or flat and can compress the second fitting portion to cause deformation and contraction thereof, rendering the second fitting portion smaller than the head portion and the engaging-connecting portion, such that the engaging portion is movably fitted to the body portion.

Preferably, the engaging portion operates in conjunction with a fitting member, such that the engaging portion is movably fitted to the body portion.

Preferably, the head portion and the engaging-connecting portion are fitted together by a screwing member.

Preferably, the fastener structure further comprises a resilient component with two ends abutting against the body portion and the engaging portion, respectively, such that the engaging portion undergoes resilient motions.

Preferably, the fastener structure is placed in a mounting member, and the fastener structure is taken out of the mounting member with a tool, and then a comparison device performs a comparing process on the fastener structure before the fastener structure is precisely placed on and fitted to the object.

Preferably, the body portion has a weldable surface for being heated up to weld the body portion to the object.

Preferably, after the body portion has been shaped by being folded or shaped by being rolled, joint portions are defined by and between adjacent folded sides or rolled sides of the body portion, and gaps or spacings are, or are not, defined between the joint portions.

Preferably, the head portion is a movable member which can be engaged with the engaging-connecting portion by being rotated, moved or pulled, allowing the engaging-connecting portion to undergo motions.

Preferably, the engaging-connecting portion is engaged with and movably fitted to the body portion, alternatively, the engaging-connecting portion is engaged with and fitted to another object.

Preferably, the body portion is shaped by being folded or shaped by being rolled to form an anchoring portion in the form of a raised portion or dented portion, such that a resilient component is anchored in place by the anchoring portion.

Preferably, the body portion is shaped by being pulled to form an anchoring portion in the form of a raised portion or dented portion, such that a resilient component is anchored in place by the anchoring portion.

Preferably, the body portion is shaped by being folded or shaped by being rolled, and the adjacent folded sides or rolled sides of the body portion can be welded and coupled together.

Preferably, at least one fitting member serving a stopping purpose is disposed between the body portion and the engaging portion, and the second fitting portion of the body portion is larger than the engaging-connecting portion, or the second fitting portion of the body portion is wider than a resilient component, wherein the fitting member prevents the engaging-connecting portion from separating from the body portion or prevents the resilient component from entering the second fitting portion.

Preferably, a transverse buoyancy is defined between the second fitting portion of the body portion and a rod portion of the engaging portion, the rod portion being disposed between the head portion and the engaging-connecting portion, and the head portion or the engaging-connecting portion is larger than the second fitting portion, such that the rod portion and the second fitting portion have buoyancy without leading to separation of the body portion and the engaging portion, alternatively, the head portion or the engaging-connecting portion is smaller than the second fitting portion, and the engaging-connecting portion is smaller than at least one fitting member, the at least one fitting member being larger than the second fitting portion, such that the fitting member stopping is disposed between the engaging-connecting portion and the body portion, thereby preventing separation of the body portion and the engaging portion.

Preferably, the body portion has a first stopping portion, and the engaging portion has a second stopping portion, wherein the first stopping portion and the second stopping portion stop each other, such that the engaging portion and the body portion are movably fitted to each other.

### BRIEF DESCRIPTION OF THE DRAWINGS

FIG. 1 is a cross-sectional view of the first embodiment of the present disclosure.

FIG. 2 is an assembled schematic view of the first embodiment of the present disclosure.

FIG. 3 is a schematic view of an engaging-connecting portion in different forms according to the present disclosure.

FIG. 4 is an assembled schematic view of the second embodiment of the present disclosure.

FIG. 5 is an assembled schematic view of the third embodiment of the present disclosure.

FIG. 6 is an assembled schematic view of the fourth embodiment of the present disclosure.

FIG. 7 is an assembled schematic view of the fifth embodiment of the present disclosure.

FIG. 8 is a cross-sectional view of the sixth embodiment of the present disclosure.

FIG. 9 is a cross-sectional view of the seventh embodiment of the present disclosure.

FIG. 10 is a schematic view of a usage state of the eighth embodiment of the present disclosure.

FIG. 11 is a schematic view of a folded state of the ninth embodiment of the present disclosure.

FIG. 12 is an assembled schematic view of the tenth embodiment of the present disclosure.

FIG. 13 is an assembled schematic view of the eleventh embodiment of the present disclosure.

FIG. 14 is a schematic view of a body portion of the twelfth embodiment of the present disclosure.

FIG. 15 is a perspective view of the twelfth embodiment of the present disclosure.

FIG. 16 is a cross-sectional view of the twelfth embodiment of the present disclosure.

FIG. 17 is an assembled schematic view of the thirteenth embodiment of the present disclosure.

FIG. 18 is a first assembled schematic view of the fourteenth embodiment of the present disclosure.

FIG. 19 is a second assembled schematic view of the fourteenth embodiment of the present disclosure.

FIG. 20 is a perspective view of the fourteenth embodiment of the present disclosure.

FIG. 21 is a post-assembly perspective view of the fifteenth embodiment of the present disclosure.

FIG. 22 is a schematic view of how to shape the body portion according to the sixteenth embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

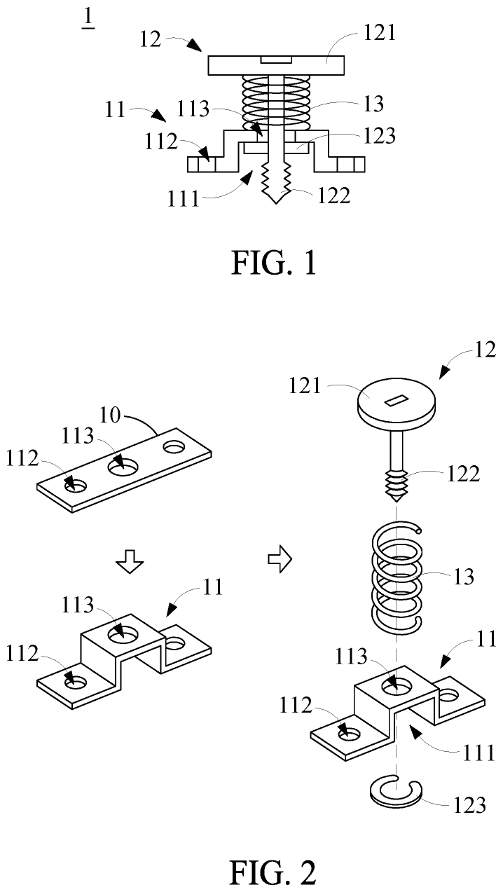

Referring to FIG. 1 through FIG. 3, the present disclosure provides a fastener structure 1 and a method of manufacturing the same. The fastener structure 1 comprises a body portion 11 and an engaging portion 12.

The body portion 11 is a plate element 10 shaped by being folded. The body portion 11 has a receiving space 111.

The engaging portion 12 is movably fitted to the body portion 11. The engaging portion 12 has a head portion 121 and an engaging-connecting portion 122. The engaging-connecting portion 122 is disposed in the receiving space 111.

To manufacture the fastener structure (as shown in FIG. 2), the plate element 10 is stamped under an applied force or pressed under an applied force so as to be shaped by being folded into the body portion 11, allowing the body portion 11 to define the receiving space 111. The receiving space 111 is a folded structure shaped by being folded. Then, the engaging-connecting portion 122 of the engaging portion 12 is disposed in the receiving space 111, such that the engaging portion 12 is movably fitted to the body portion 11, so as to form the fastener structure 1 (as shown in FIG. 1). Therefore, the fastener structure 1 is easy to manufacture.

To use the fastener structure, a user fits the body portion 11 to an object (not shown) and exerts a force on the head portion 121 of the engaging portion 12, such that the engaging-connecting portion 122 is engaged with another object. To remove the another object, the user exerts a force on the head portion 121 of the engaging portion 12, such that the engaging-connecting portion 122 is separated from the another object. Therefore, the engaging-connecting portion 122 of the engaging portion 12 is engaged with the another object or removed from the another object, so as to not only fit together and separate at least two objects repeatedly and quickly but also render the fastener structure easy to manufacture.

In a preferred embodiment of the present disclosure, the plate element 10 or the body portion 11 shaped has a first fitting portion 112. The first fitting portion 112 is a hole portion, slot portion, raised portion, dented portion, plane portion, welding portion, engaging portion, fastening portion, riveting portion, expanding portion or engaging-connecting portion. The first fitting portion 112 is fitted to an object. Therefore, the body portion 12 is firmly fitted to the object by the first fitting portion 112 to facilitate the operation of the engaging portion 12, such that the engaging-connecting portion 122 of the engaging portion 12 is engaged with the another object or removed from the another object.

In a preferred embodiment of the present disclosure, the plate element 10 or the body portion 11 shaped has a second fitting portion 113. The second fitting portion 113 is fitted to the engaging portion 12. Therefore, the engaging portion 12 is firmly, movably fitted to the body portion 11 to facilitate the operation of the engaging portion 12, so as for the present disclosure to meet actual application needs.

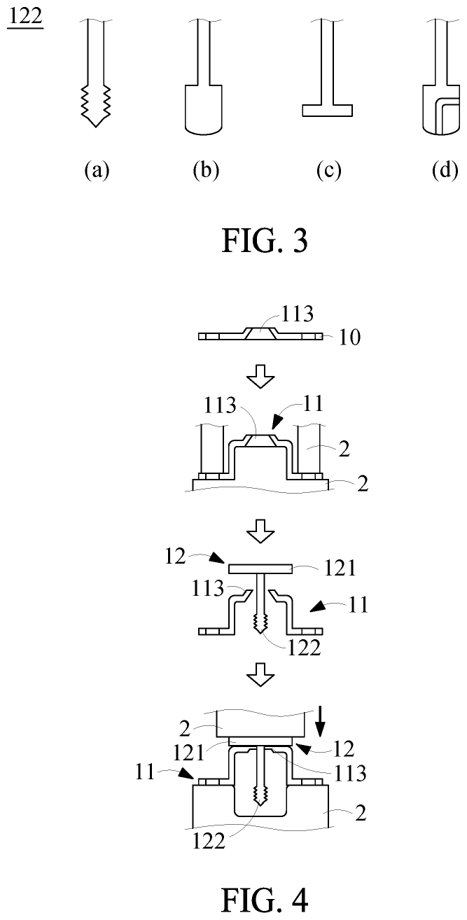

In a preferred embodiment of the present disclosure, the engaging-connecting portion 122 is a thread member (part a in FIG. 3), cylindrical member (part b in FIG. 3), external fastener (part c in FIG. 3) or internal fastener (part d in FIG. 3). Therefore, the engaging-connecting portion 122 of the engaging portion 12 can be engaged with different objects as needed, allowing the present disclosure to meet actual application needs.

In a preferred embodiment of the present disclosure, the engaging portion 12 operates in conjunction with a fitting member 123 whereby the engaging portion 12 is movably fitted to the body portion 11. Therefore, the engaging portion 12 is firmly, movably fitted to the body portion 11 to enhance stability in the course of assembly and operation.

In a preferred embodiment of the present disclosure, the fastener structure 1 further comprises a resilient component 13. The two ends of the resilient component 13 abut against the body portion 11 and the engaging portion 12, respectively, such that the engaging portion 12 can undergo resilient motions. Therefore, to use the fastener structure 1, the user applies a force on the head portion 121 of the engaging portion 12, such that the engaging-connecting portion 122 is engaged with another object and compresses the resilient component 13. To remove the another object, the user applies a force on the head portion 121 of the engaging portion 12 to separate the engaging-connecting portion 122 from the another object, release the resilient component 13, and reinstate the engaging portion 12, so as to allow for the next instance of the use of the fastener structure 1. Therefore, the engaging-connecting portion 122 of the engaging portion 12 is engaged with the another object or removed from the another object, so as to not only fit together and separate at least two objects repeatedly and quickly but also render the fastener structure easy to manufacture.

Referring to FIG. 4 in a preferred embodiment of the present disclosure, with a die 2, the plate element 10 is stamped, i.e., shaped by being folded, to become the body portion 11. The body portion 11 has the second fitting portion 113 which is raised (dented or flat) and can compress the second fitting portion 113 to cause deformation and contraction thereof, rendering the second fitting portion 113 smaller than the head portion 121 and the engaging-connecting portion 122 of the engaging portion 12, such that the engaging portion 12 is movably fitted to the body portion 11. Therefore, the engaging portion 12 is firmly, movably fitted to the body portion 11 to enhance stability in the course of assembly and operation.

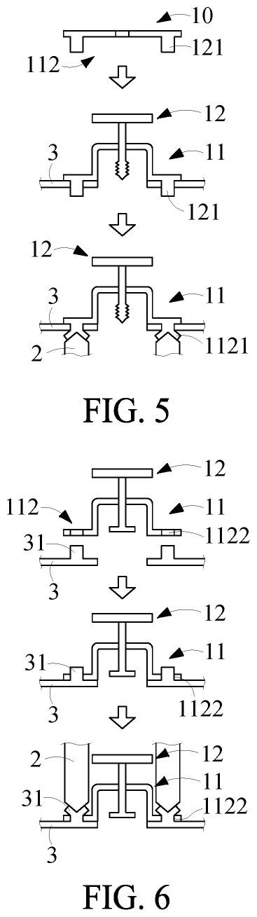

Referring to FIG. 5 and FIG. 6 in a preferred embodiment of the present disclosure, the first fitting portion 112 has a raised portion 1121. The raised portion 1121 is compressed by the die 2 or is engaged with an object 3 (as shown in FIG. 5). The first fitting portion 112 has a hole portion 1122 which is compressed by or engaged with the raised portion 31 of the object 3, with the die 2, so as to fit to the object 3 (as shown in FIG. 6). Furthermore, the first fitting portion 112 has a slot portion or dented portion, as needed, so as to be fitted to the object 3 (not shown).

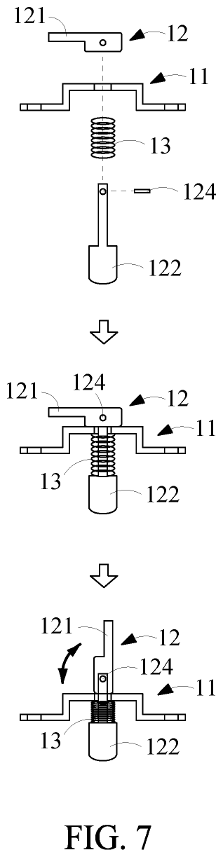

Referring to FIG. 7, in a preferred embodiment of the present disclosure, the head portion 121 and the engaging-connecting portion 122 of the engaging portion 12 are fitted together by a screwing member 124. In this embodiment, the head portion 121 is a movable member which can be engaged with the engaging-connecting portion 122 by being rotated, moved or pulled, allowing the engaging-connecting portion 122 to undergo motions, such that the engaging-connecting portion 122 of the engaging portion 12 is engaged with the another object or removed from the another object.

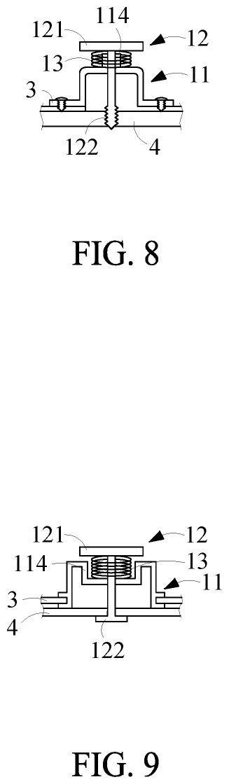

Referring to FIG. 8 and FIG. 9, in a preferred embodiment of the present disclosure, the body portion 11 is shaped by being folded to form an anchoring portion 114 in the form of a raised portion (as shown in FIG. 8) or a dented portion (as shown in FIG. 9). Given the anchoring portion 114, the resilient component 13 is anchored in place. The engaging-connecting portion 122 is movably engaged with and thus fitted to the body portion 11. The engaging-connecting portion 122 is engaged with and fitted to another object 4. Therefore, to use the fastener structure 1, the user fits the body portion 11 to the object 3 and applies a force on the head portion 121 of the engaging portion 12, such that the engaging-connecting portion 122 is engaged with another object 4 and compresses the resilient component 13. To remove the another object 4, the user applies a force on the head portion 121 of the engaging portion 12 to separate the engaging-connecting portion 122 from the another object 4, release the resilient component 13, and reinstate the engaging portion 12, so as to allow for the next instance of the use of the fastener structure 1. Therefore, the engaging-connecting portion 122 of the engaging portion 12 is engaged with the another object 4 or removed from the another object 4, so as to not only fit together and separate at least two objects repeatedly and quickly but also render the fastener structure easy to manufacture.

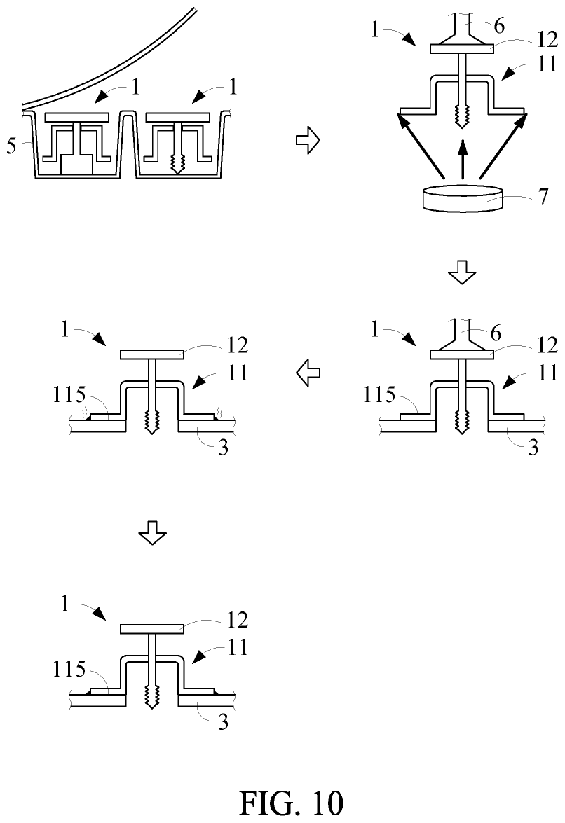

Referring to FIG. 10, in a preferred embodiment of the present disclosure, the fastener structure 1 is placed in a mounting member 5, and the fastener structure 1 is taken out of the mounting member 5 with a tool 6. Then, a comparison device 7 performs a comparing process on the fastener structure 1 before the fastener structure 1 is precisely placed on and fitted to the object 3. In this embodiment, the body portion 11 has a weldable surface 115 for being heated up to weld the body portion 11 to the object 3. Therefore, the body portion 12 is firmly fitted to the object 3 to not only facilitate the operation of the engaging portion 12 but also allow the engaging portion 12 to be engaged with the another object or removed from the another object.

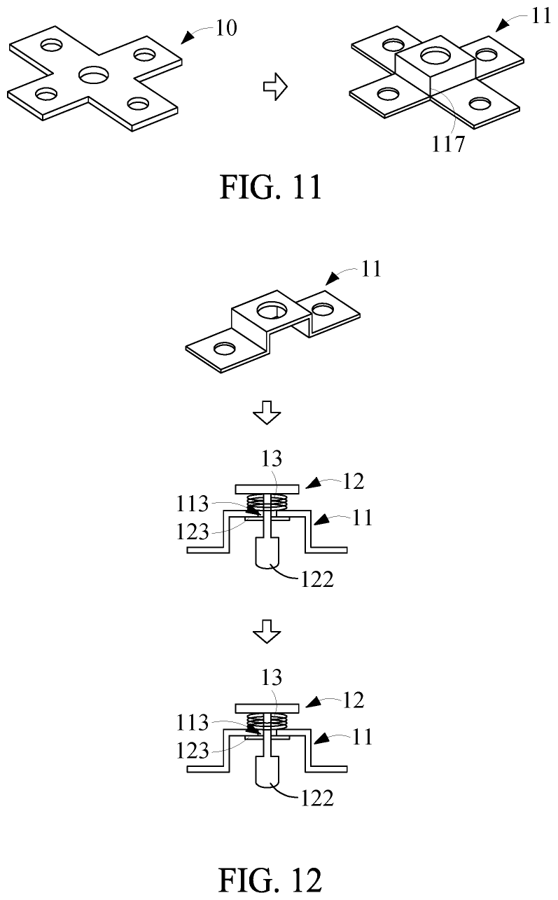

Referring to FIG. 11, in a preferred embodiment of the present disclosure, after the plate element 10 has been shaped by being folded to become the body portion 11, joint portions 117 are defined by and between adjacent folded sides of the body portion 11. Not only are the joint portions 117 each free of any gap or spacing, but the adjacent folded sides can also be welded and coupled together with a tool, allowing the present disclosure to meet actual application needs.

Referring to FIG. 12, in a preferred embodiment of the present disclosure, after the plate element 10 has been shaped by being folded to become the body portion 11, at least one fitting member 123 serving a stopping purpose is disposed between the body portion 11 and the engaging portion 12. The second fitting portion 113 of the body portion 11 is larger than the engaging-connecting portion 122. Alternatively, the second fitting portion 113 of the body portion 11 is wider than the resilient component 13. The fitting member 123 prevents the engaging-connecting portion 122 from separating from the body portion 11 or prevents the resilient component 13 from entering the second fitting portion 113, thereby allowing the present disclosure to meet usage needs.

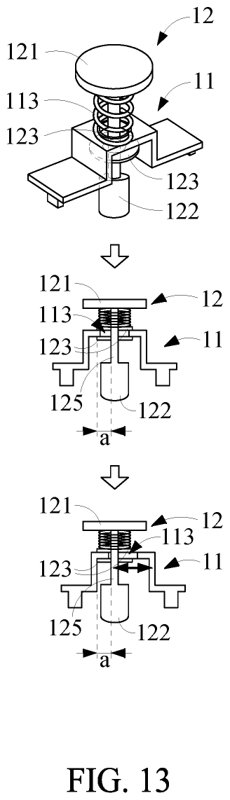

Referring to FIG. 13, in a preferred embodiment of the present disclosure, a transverse buoyancy B is defined between the second fitting portion 113 of the body portion 11 and a rod portion 125 of the engaging portion 12. The rod portion 125 is disposed between the head portion 121 and the engaging-connecting portion 122. The head portion 121 and the engaging-connecting portion 122 are larger than the second fitting portion 113, such that the rod portion 125 and the second fitting portion 113 have buoyancy B without leading to separation of the body portion 11 and the engaging portion 2. Alternatively, the head portion 121 and the engaging-connecting portion 122 are smaller than the second fitting portion 113, and the engaging-connecting portion 122 is smaller than two fitting members 123. The fitting members 123 are larger than the second fitting portion 113. Thus, the fitting members 123 are stopped between the engaging-connecting portion 122 and the body portion 11, preventing separation of the body portion 11 and the engaging portion 12. Therefore, the body portion 12 is firmly fitted to the body portion 11 to facilitate the operation of the engaging portion 12.

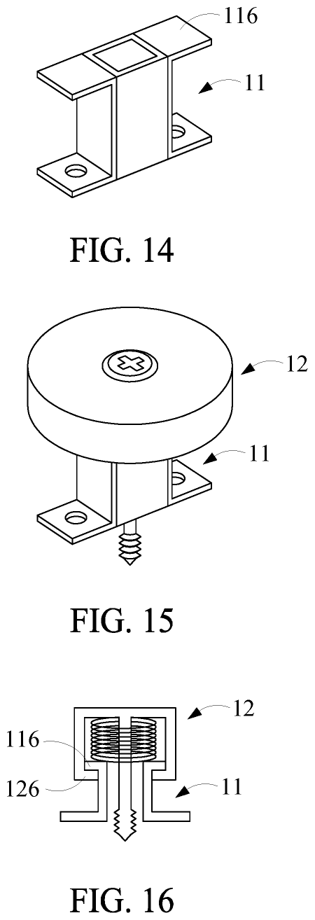

Referring to FIG. 14 through FIG. 16, in a preferred embodiment of the present disclosure, the body portion 11 has a first stopping portion 116, whereas the engaging portion 12 has a second stopping portion 126. The first stopping portion 116 and the second stopping portion 126 stop each other, such that the engaging portion 12 and the body portion 11 are movably fitted to each other. Therefore, the body portion 12 is firmly fitted to the body portion 11 to facilitate the operation of the engaging portion 12.

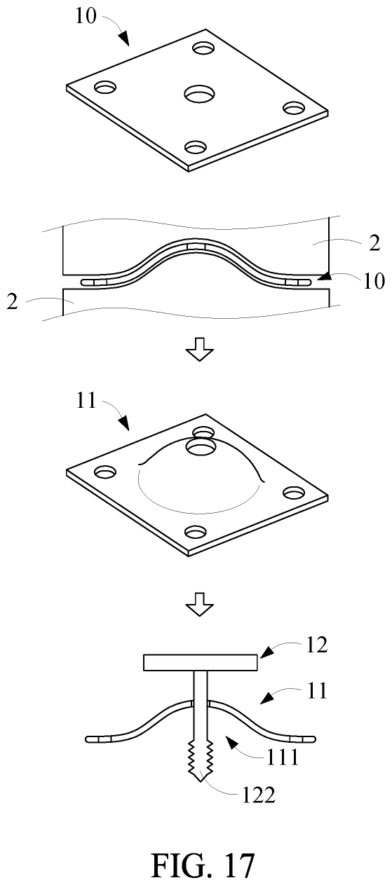

Referring to FIG. 17, in a preferred embodiment of the present disclosure, the body portion 11 is the plate element 10 stamped under an applied force or pressed under an applied force so as to be shaped by being pulled, allowing the body portion 11 to have the receiving space 111. During the shaping process, with the die 2, the plate element 10 is stamped and shaped by being pulled to become the body portion 11, such that the receiving space 111 is a closed structure formed by pulling the material of the plate element 10. The engaging portion 12 is movably fitted to the body portion 11. The engaging-connecting portion 121 of the engaging portion 12 is disposed in the receiving space 111. Therefore, the body portion 11 is fitted to an object, and the engaging-connecting portion 121 of the engaging portion 12 is removed from another object, so as to not only fit together and separate at least two objects repeatedly and quickly but also render the fastener structure easy to manufacture.

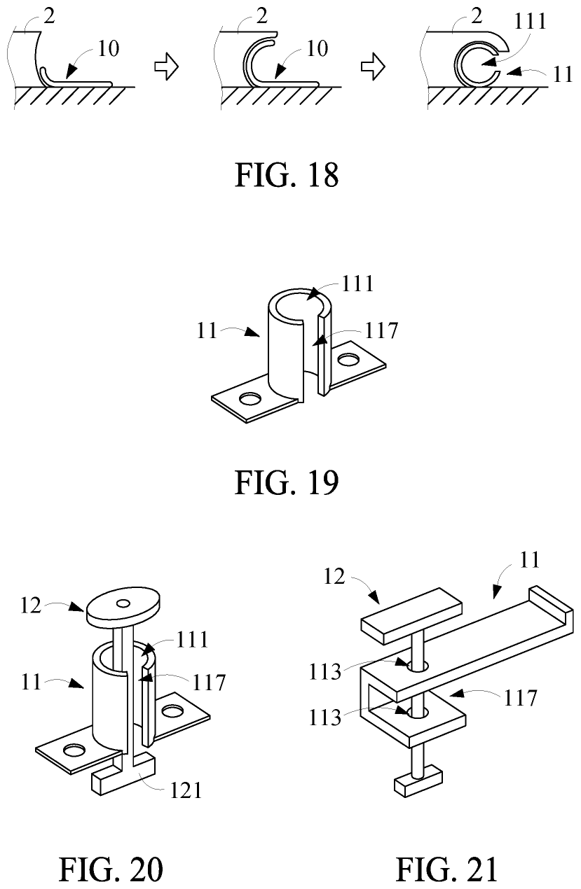

Referring to FIG. 18 through FIG. 20, in a preferred embodiment of the present disclosure, the body portion 11 is the plate element 10 stamped under an applied force or pressed under an applied force so as to be shaped by being rolled, allowing the body portion 11 to have the receiving space 111. During the shaping process, with different dies 2, the plate element 10 is pressed under an applied force and thus shaped by being rolled to become the body portion 11. The engaging portion 12 is movably fitted to the body portion 11. The engaging-connecting portion 121 of the engaging portion 12 is disposed in the receiving space 111. The joint portions 117 are defined by and between adjacent folded sides of the body portion 11. Gaps or spacings are defined between the joint portions 117. Therefore, the body portion 11 is fitted to an object, and the engaging-connecting portion 121 of the engaging portion 12 is removed from another object, so as to not only fit together and separate at least two objects repeatedly and quickly but also render the fastener structure easy to manufacture.

Referring to FIG. 21, in a preferred embodiment of the present disclosure, the plate element 10 or the body portion 11 shaped has two second fitting portions 113. The second fitting portions 113 are fitted to the engaging portion 12. The joint portions 117 are defined by and between adjacent folded sides of the body portion 11. Gaps or spacings are defined between the joint portions 117. Therefore, the engaging portion 12 is firmly, movably fitted to the body portion 11 to facilitate the operation of the engaging portion 12, allowing the present disclosure to meet actual application needs.

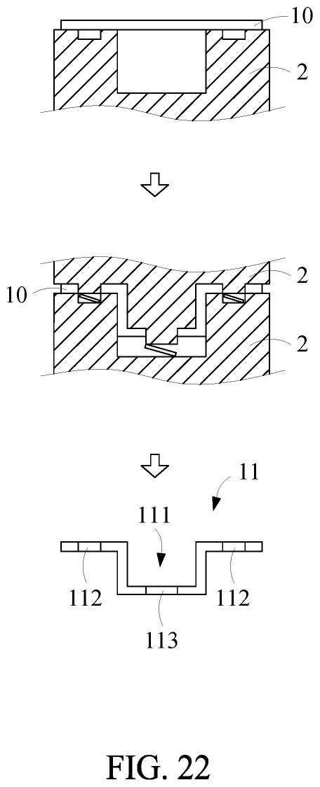

Referring to FIG. 22, in a preferred embodiment of the present disclosure, the plate element 10 is stamped under an applied force so as to be shaped by being folded into the body portion 11, allowing the body portion 11 to form the receiving space 111, the first fitting portion 112 and the second fitting portions 113. Therefore, not only is the body portion 11 formed by stamping, but the fastener structure 1 is also easy to manufacture.

In conclusion, preferred embodiments of the present disclosure provide a fastener structure and a method of manufacturing the same, which involve movably fitting together a body portion and an engaging portion, fitting the body portion to an object, and allowing the engaging portion to be engaged with another object or removed from another object, so as to not only fit together and separate at least two objects repeatedly and quickly but also render the fastener structure easy to manufacture.

While the present disclosure has been described by means of specific embodiments, numerous modifications and variations could be made thereto by those skilled in the art without departing from the scope and spirit of the present disclosure set forth in the claims.

What is claimed is:

1. A fastener structure, comprising:
a body portion formed from a plate element shaped by being folded or shaped by being rolled, the body portion having a receiving space; and
an engaging portion movably fitted to the body portion and having a head portion and an engaging-connecting portion.

2. A fastener structure, comprising:
a body portion formed from a plate element shaped by being pulled, the body portion having a receiving space; and
an engaging portion movably fitted to the body portion and having a head portion and an engaging-connecting portion.

3. The fastener structure of claim 1, wherein the plate element or the body portion shaped has a first fitting portion, the first fitting portion being fitted to an object and having a raised portion, the raised portion being compressed or being engaged with the object so as to be fitted thereto.

4. The fastener structure of claim 2, wherein the plate element or the body portion shaped has a first fitting portion, the first fitting portion being fitted to an object and having a raised portion, the raised portion being compressed or being engaged with the object so as to be fitted thereto.

5. The fastener structure of claim 1, wherein the plate element or the body portion shaped has one or two second fitting portions fitted to the engaging portion.

6. The fastener structure of claim 2, wherein the plate element or the body portion shaped has one or two second fitting portions fitted to the engaging portion.

7. The fastener structure of claim 1, wherein the body portion has a second fitting portion which is raised, dented or flat and can compress the second fitting portion to cause deformation and contraction thereof, rendering the second fitting portion smaller than the head portion and the engaging-connecting portion, such that the engaging portion is movably fitted to the body portion.

8. The fastener structure of claim 2, wherein the body portion has a second fitting portion which is raised, dented or flat and can compress the second fitting portion to cause deformation and contraction thereof, rendering the second fitting portion smaller than the head portion and the engaging-connecting portion, such that the engaging portion is movably fitted to the body portion.

9. The fastener structure of claim 1, wherein the engaging portion operates in conjunction with a fitting member, such that the engaging portion is movably fitted to the body portion.

10. The fastener structure of claim 2, wherein the engaging portion operates in conjunction with a fitting member, such that the engaging portion is movably fitted to the body portion.

11. The fastener structure of claim 1, wherein the head portion and the engaging-connecting portion are fitted together by a screwing member.

12. The fastener structure of claim 2, wherein the head portion and the engaging-connecting portion are fitted together by a screwing member.

13. The fastener structure of claim 1, further comprising a resilient component with two ends abutting against the body portion and the engaging portion, respectively, such that the engaging portion undergoes resilient motions.

14. The fastener structure of claim 2, further comprising a resilient component with two ends abutting against the body portion and the engaging portion, respectively, such that the engaging portion undergoes resilient motions.

15. The fastener structure of claim 1, wherein, after the body portion has been shaped by being folded or shaped by being rolled, joint portions are defined by and between adjacent folded sides or rolled sides of the body portion, and gaps or spacings are, or are not, defined between the joint portions.

16. The fastener structure of claim 1, wherein the head portion is a movable member which can be engaged with the engaging-connecting portion by being rotated, moved or pulled, allowing the engaging-connecting portion to undergo motions.

17. The fastener structure of claim 2, wherein the head portion is a movable member which can be engaged with the engaging-connecting portion by being rotated, moved or pulled, allowing the engaging-connecting portion to undergo motions.

18. The fastener structure of claim 1, wherein the engaging-connecting portion is engaged with and movably fitted to the body portion, alternatively, the engaging-connecting portion is engaged with and fitted to another object.

19. The fastener structure of claim 2, wherein the engaging-connecting portion is engaged with and movably fitted to the body portion, alternatively, the engaging-connecting portion is engaged with and fitted to another object.

20. The fastener structure of claim 1, wherein the body portion is shaped by being folded or shaped by being rolled to form an anchoring portion in form of a raised portion or a dented portion, such that the resilient component is anchored in place by the anchoring portion.

21. The fastener structure of claim 2, wherein the body portion is shaped by being pulled to form an anchoring portion in form of a raised portion or dented portion, such that a resilient component is anchored in place by the anchoring portion.

22. The fastener structure of claim 1, wherein at least one fitting member serving a stopping purpose is disposed between the body portion and the engaging portion, and the second fitting portion of the body portion is larger than the engaging-connecting portion, or the second fitting portion of the body portion is wider than a resilient component, wherein the fitting member prevents the engaging-connecting portion from separating from the body portion or prevents the resilient component from entering the second fitting portion.

23. The fastener structure of claim 2, wherein at least one fitting member serving a stopping purpose is disposed between the body portion and the engaging portion, and the second fitting portion of the body portion is larger than the engaging-connecting portion, or the second fitting portion of the body portion is wider than a resilient component, wherein the fitting member prevents the engaging-connecting portion from separating from the body portion or prevents the resilient component from entering the second fitting portion.

24. The fastener structure of claim 1, wherein a transverse buoyancy is defined between the second fitting portion of the body portion and a rod portion of the engaging portion, the rod portion being disposed between the head portion and the engaging-connecting portion, and the head portion or the engaging-connecting portion is larger than the second fitting portion, such that the rod portion and the second fitting portion have buoyancy without leading to separation of the body portion and the engaging portion, alternatively, the head portion or the engaging-connecting portion is smaller than the second fitting portion, and the engaging-connecting portion is smaller than at least one fitting member, the at least one fitting member being larger than the second fitting portion, such that the fitting member stopping is disposed between the engaging-connecting portion and the body portion, thereby preventing separation of the body portion and the engaging portion.

25. The fastener structure of claim 2, wherein a transverse buoyancy is defined between the second fitting portion of the body portion and a rod portion of the engaging portion, the rod portion being disposed between the head portion and the engaging-connecting portion, and the head portion or the engaging-connecting portion is larger than the second fitting portion, such that the rod portion and the second fitting portion have buoyancy without leading to separation of the body portion and the engaging portion, alternatively, the head portion or the engaging-connecting portion is smaller than the second fitting portion, and the engaging-connecting portion is smaller than at least one fitting member, the at least one fitting member being larger than the second fitting portion, such that the fitting member stopping is disposed between the engaging-connecting portion and the body portion, thereby preventing separation of the body portion and the engaging portion.

26. The fastener structure of claim 1, wherein the body portion has a first stopping portion, and the engaging portion has a second stopping portion, wherein the first stopping portion and the second stopping portion stop each other, such that the engaging portion and the body portion are movably fitted to each other.

27. The fastener structure of claim 2, wherein the body portion has a first stopping portion, and the engaging portion has a second stopping portion, wherein the first stopping portion and the second stopping portion stop each other, such that the engaging portion and the body portion are movably fitted to each other.

28. A method of manufacturing the fastener structure of claim 1, the fastener structure comprising a body portion and an engaging portion, the body portion being formed from a plate element shaped by being folded, shaped by being rolled or shaped by being pulled, allowing the body portion to form a receiving space, the engaging portion having a head portion and an engaging-connecting portion, the engaging portion being movably fitted to the body portion, allowing the engaging-connecting portion to be disposed inside or outside the receiving space.

29. A method of manufacturing the fastener structure of claim 2, the fastener structure comprising a body portion and an engaging portion, the body portion being formed from a plate element shaped by being folded, shaped by being rolled or shaped by being pulled, allowing the body portion to form a receiving space, the engaging portion having a head portion and an engaging-connecting portion, the engaging portion being movably fitted to the body portion, allowing the engaging-connecting portion to be disposed inside or outside the receiving space.

30. A method of manufacturing the fastener structure of claim 1, the fastener structure comprising a body portion and an engaging portion, the body portion being formed by stamping or pressing a plate element under an applied force so as for the plate element to be shaped by being folded, shaped by being rolled or shaped by being pulled, allowing a receiving space to be formed by the body portion, wherein the engaging portion has a head portion and an engaging-connecting portion, and the engaging portion is movably fitted to the body portion, allowing the engaging-connecting portion to be disposed inside or outside the receiving space.

31. A method of manufacturing the fastener structure of claim 2, the fastener structure comprising a body portion and an engaging portion, the body portion being formed by stamping or pressing a plate element under an applied force so as for the plate element to be shaped by being folded, shaped by being rolled or shaped by being pulled, allowing a receiving space to be formed by the body portion, wherein the engaging portion has a head portion and an engaging-connecting portion, and the engaging portion is movably fitted to the body portion, allowing the engaging-connecting portion to be disposed inside or outside the receiving space.
